(19) United States
(12) Patent Application Publication
(10) Pub. No.: US 2004/0060773 A1
(43) Pub. Date: Apr. 1, 2004

(54) Rescue system for high-rise buildings

(76) Inventor: Eliyahu Nir, Netania (IL)

Correspondence Address: G E Ehrlich, Anthony Castorina, Suite 207, 2001 Jefferson Davis Highway, Arlington, VA, 22202, US

(21) Appl. No.: 10/415,990

(22) PCT Filed: Nov. 5, 2001
(86) PCT No.: PCT/IL01/01022

(30) Foreign Application Priority Data
Nov. 8, 2000 (IL) 139550

(51) Int. Cl. A62B 1/20

(52) U.S. Cl. 182/48; 182/70

(57) ABSTRACT

A system for use in conjunction with emergency rescue sleeves that are mechanically deployed along at least a pair of supporting cables taught between a compacted sleeve storage compartment located at a designated story of a building and an anchor located at a point elsewhere below. The system is further provided with a launching device (200) for propelling a projectile body (216) from the storage location down to a predetermined target location (220) at another building (230). The projectile (216) is tied by a length of wire (218) to one of the supporting cables (127). The projectile (216) is shot to the target location (220) and the cable (127) is taught and anchored inside the building (230). The unfolding of the sleeve (112) proceeds in the known manner.

### FIELD OF THE INVENTION

The present invention relates to rescue systems for evacuating individuals trapped in high rise buildings in case of emergency situations such as fire or earthquake of the type disclosed in PCT/IL0/00477 patent application published as WO 01/62138 on Aug. 30, 2001 (hereinafter called “the WO Patent”), the contents of which being hereby incorporated by reference.

More specifically the invention concerns a system of the kind disclosed in the WO Patent wherein the exit side of the rescue sleeve is designed to be anchored not necessarily at the ground level location.

### BACKGROUND OF THE INVENTION

As clearly follows in light of the description contained in the WO Patent, it has been taken for granted that the rescue sleeve, ejected from its storage compartment, becomes unfolded along at least two guiding and supporting cables which are anchored to stationary object(s) located at the ground (street) level, in front of the building in question.

This, however, may not always be practicable due, among other reasons, to the particular environmental conditions prevailing in the immediate surrounding of the building. This is particularly true since a certain minimum distance between the building and the anchoring point must be preserved in order to attain a suitable inclination angle of the sleeve (say 45°), which distance enlarges in proportion to the height of the story from which the evacuation is requested.

It is therefore the prime object of the present invention to attain control over the direction and destination point of the rescue sleeve.

It is a further object of the invention to facilitate the directing or piloting of the sleeve, not only to the ground but also, if desired, to a predetermined other location, such as a high-rise building across the street into which evacuation will take place.

### SUMMARY OF THE INVENTION

Thus provided according to the invention is a system for the evacuation of individuals trapped in multiple story buildings by gliding down a rescue sleeve, comprising: a sleeve made of sections, each section being made of a sheet material strengthened by a circumferential support member, the sections being connected to each other to form a continuous envelope; at least a pair of cables thread along the sleeve, one at the bottom and one at the top generatrix thereof; a pair of winch systems for winding the cables into a dedicated location at the building story from which rescue is requested, so that the sleeve becomes folded into a compact package; coil spring operated means for selectively ejecting and unfolding the sleeve down to ground level where it becomes tied to stationary object(s), characterized by a device for propelling a projectile body from said dedicated location down to a predetermined target location outside the building, the projectile body being tied by a length of wire to the top cable for enabling the anchoring thereof at the target location.

### BRIEF DESCRIPTION OF THE DRAWINGS

Further constructional details and advantages of the invention will be more clearly understood in the light of the ensuing description of a preferred embodiment thereof, given by way of example only, with reference to the accompanying drawings, wherein-

FIG. 1 is a longitudinal cross-sectional view of the sleeve stand-by storing compartment with a projectile propelling device provided according to the present invention;

FIG. 2 shows the propelling device on an enlarged scale;

FIG. 3 is a detail of construction shown by a section taken along line III-III of FIG. 1;

FIG. 4 shows the propelling device shortly after actuation;

FIG. 5 is a detail of construction shown by a section taken along line V-V of FIG. 4;

FIG. 6 illustrates the projectile trajectory between two buildings; and

FIG. 7 shows a bowl shaped collector for the projectile on an enlarged scale.

FIG. 8 shows the sleeve deployed between the evacuated building and a building located, say across the street; and

FIG. 9 is a detail illustrating the sleeve entering the second building.

### DETAILED DESCRIPTION OF THE PREFERRED EMBODIMENTS

In the attached drawings, numerals with the prefix “1” will be used to designate parts and components corresponding to those of WO Patent; other parts will bear “2” as a prefix.

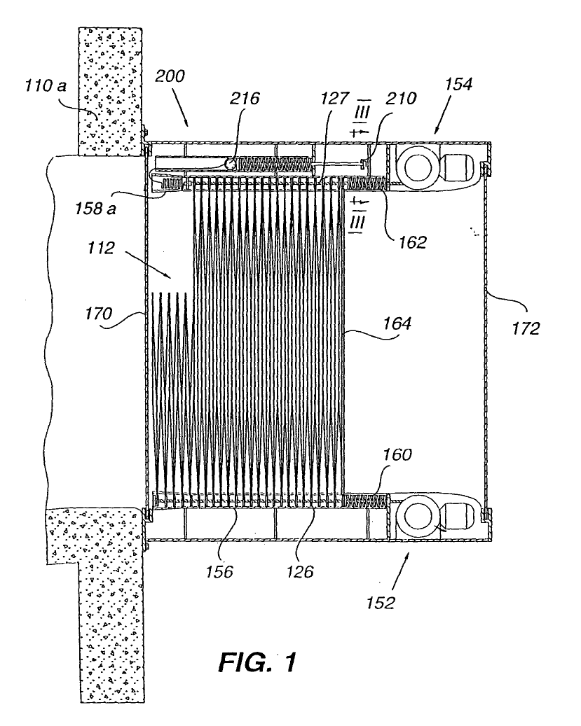

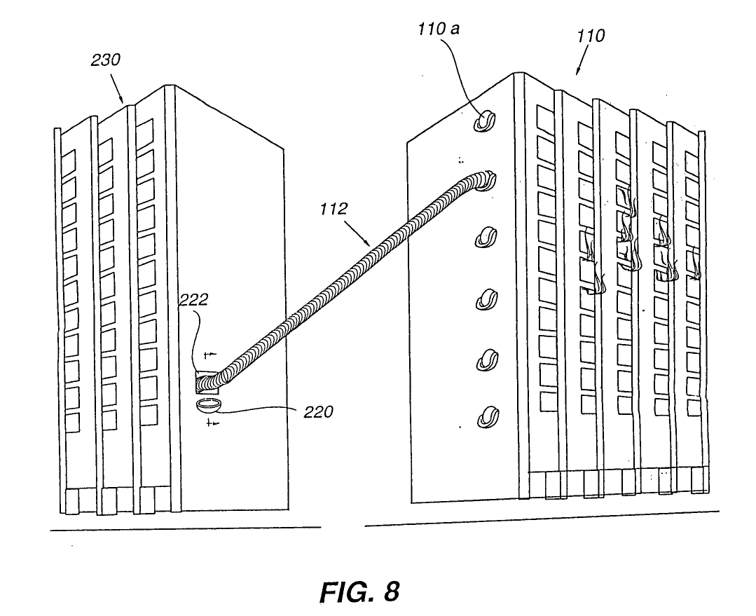

Hence, FIG. 1 includes all the details of FIG. 8 of the WO Patent and therefore need not be repeated. In addition, however, there is incorporated the projectile shooting device generally designated 200, operatively associated with the upper cable 127 and its guiding tube 158.

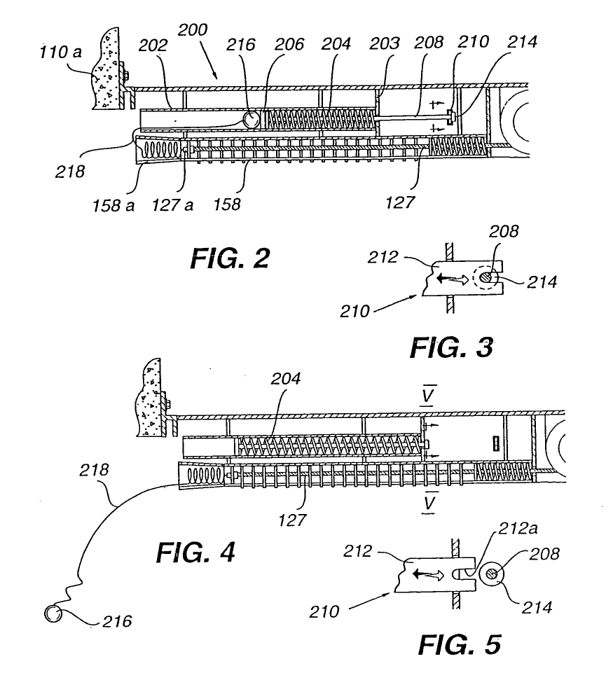

As more clearly seen in FIG. 2, the device 200 comprises a tube 202 closed at one side 203 and accommodating a compression coil spring 204. The spring 204 is in its cocked, compressed position attained by plug 206 having been pulled back by rod 208 to an extent that trigger-head 210 becomes engaged by a trigger-releasing device 210—see FIGS. 3 and 5.

The device 210 may be of any suitable type, such as comprising a retractable plate 212 with an open-sided slot 212a (FIG. 5) adapted to receive the head 214 of the rod 208. Retraction of the plate 212 can be achieved by mechanical or electrical means (not shown).

A projectile, in the form of a metal ball 216 is provided, connected by a wire 218 of a sufficient length (see below) to the leading end 127a of the upper cable 127 (see FIG. 2 of the WO Patent).

The excessive length of the wire 218, which may be of the thin, but strong, “fishermen” type, is coiled around a spool and stored inside the free pace left at the open end of the tube 158.

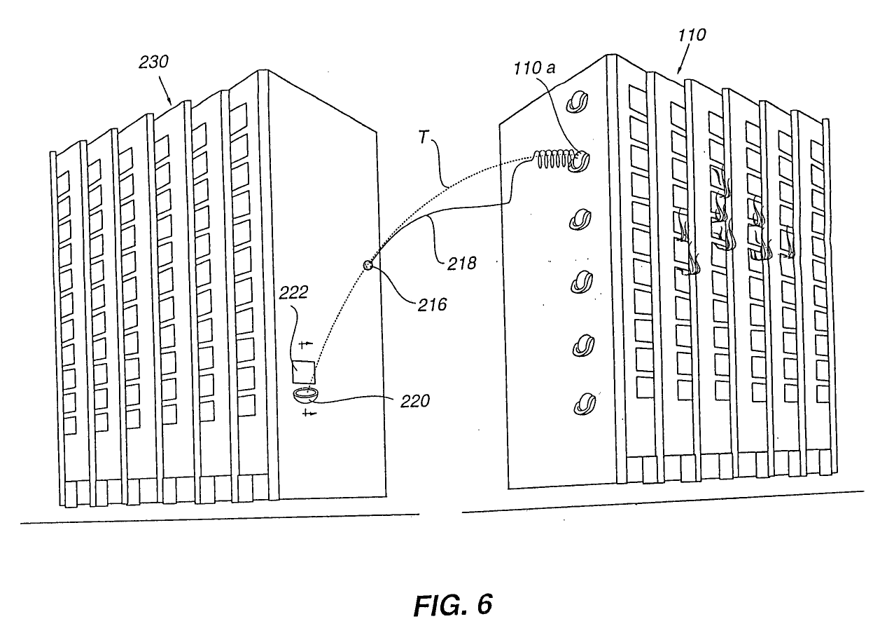

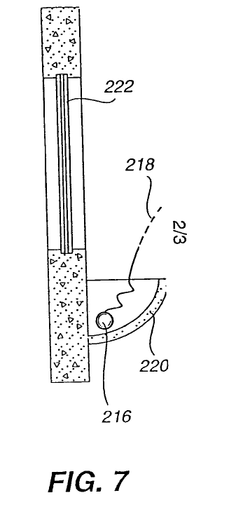

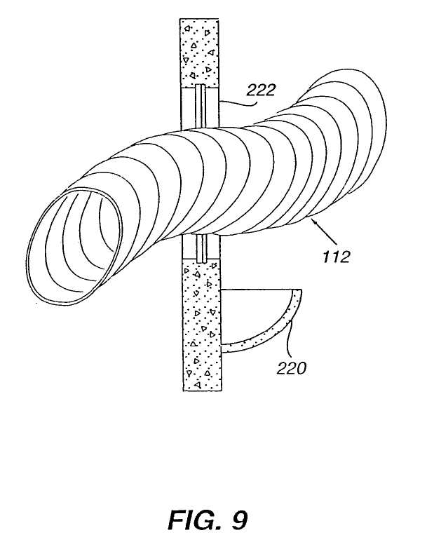

The operation of projectile shooting device is clearly illustrated by FIGS. 6-9.

Upon emergency situation, e.g. fire in the building 110, and prior to the launching of the rescue sleeve 112 as described in the WO Patent, the projectile 216 is shot by releasing the rod 208 off the trigger device 210.

The projectile ballistic trajectory T is shown, drawn between the rescue sleeve ejecting opening 110a and a bowl shaped collector 220 provided at a lower story of the outer wall of a near-by building 230 (FIG. 6).

Obviously other collectors of the projectile 212 can be selected; also, the projectile guided method is also applicable for evacuation to ground level as exemplified in the WO Patent.

The trajectory is calculated and practically ascertained beforehand, taking into consideration all factors such as the spring 204 impact, the projectile 216 mass, the angle of the tube 202 relative to the horizontal, the distance and relative height difference, etc. etc., all to ensure that the projectile 216 will safely land into the bowl shaped collector 220.

A rescue team in charge of the building 230 will be trained to and responsible for fetching the ball 216 by reaching through opening 222 provided for that purpose. Once the wire 218 is under control of the rescue team, the sleeve system 112 is launched in the same manner as described in the WO Patent.

By collecting the wire 218, the leading end of the upper support cable 127 is brought into the building 230 (rather than falling down to the ground) and anchored in preparation for the guided slide of the sleeve therealong. The second, lower support cable 126 can be anchored later on (if necessary for the rescue process itself as opposed to the folding-back stage).

Various changes and modifications of the invention will be apparent.

What is claimed is:

1. A system for the evacuation of individuals trapped in multiple story buildings by gliding down a rescue sleeve, comprising: a sleeve (112) made of sections, each section being made of a sheet material strengthened by a circumferential support member, the sections being connected to each other to form a continuous envelope; at least a pair of cables (126; 127) thread along the sleeve, one at the bottom and one at the top generatrix thereof; a pair of winch systems (152; 154) for winding the cables into a dedicated location at the building story from which rescue is requested, so that the sleeve (112) becomes folded into a compact package; coil spring operated means (160; 162) for selectively ejecting and unfolding the sleeve down to ground level where it becomes tied to stationary object(s), characterized by a device (200) for propelling a projectile body (216) from said dedicated location down to a predetermined target location (220) outside the building, the projectile body (216) being tied by a length of wire (218) to the top cable (127) for enabling the anchoring thereof at the target location.

2. The system as claimed in claim 1 wherein the device (200) comprises a compression spring (204) retractable into a compressed state and means for applying the impact of the spring to the projectile body (216) upon being released from the retracted state thereof.

3. The system as claimed in claim 2 wherein the spring (204) is stored within a tubular housing (202) located above and parallel to the top cable guide tube (158).

4. The system as claimed in claim 2 wherein the predetermined target location (220) is a rescue opening (222) at a lower level of another, near-by building (230).

5. The system as claimed in claim 4 wherein a collecting receptacle (220) is provided at the wall of said other building (230).
